(19) United States
(12) Patent Application Publication
(10) Pub. No.: US 2022/0391619 A1
(43) Pub. Date: Dec. 8, 2022

(54) INTERACTIVE AUGMENTED REALITY DISPLAYS

(71) Applicant: AT&T Intellectual Property I, L.P., Atlanta, GA (US)

(72) Inventors: Walter Cooper Chastain, Atlanta, GA (US); Barrett Kreiner, Woodstock, GA (US); James Pratt, Round Rock, TX (US); Adrianne Luu, Atlanta, GA (US); Robert Moton, JR., Alpharetta, GA (US); Robert Koch, Peachtree Corners, GA (US); Ari Craine, Marietta, GA (US)

(21) Appl. No.: 17/338,656

(22) Filed: Jun. 3, 2021

(51) Int. Cl. G06K 9/00; G06T 11/00; G06T 7/70; G06F 3/16; G06F 9/451

(52) U.S. Cl. CPC G06K 9/00671; G06T 11/00; G06T 7/70; G06F 3/167; G06F 9/451; G06Q 10/02

(57) ABSTRACT

In one example, a method performed by a processing system including at least one processor includes detecting an input from a user of an augmented reality display that is deployed within a window, the input indicating that the user is seeking additional information about a real world object that is viewable through the window, identifying the real world object for which the user is seeking additional information, based on the input from the user and a reference map, retrieving information about the real world object from a data source, and modifying the augmented reality display to present the information about the real world object.

The present disclosure relates generally to augmented reality (AR) systems, and relates more particularly to devices, non-transitory computer-readable media, and methods for generating and displaying interactive, augmented reality displays.

### BACKGROUND

Augmented reality (AR) comprises a subset of extended reality (XR) technology in which objects that reside in the real world are augmented with computer-generated information. AR may thus be used to enhance real world environments or situations and offer perceptually enriched or immersive experiences.

### SUMMARY

In one example, the present disclosure describes a device, computer-readable medium, and method for providing interactive augmented reality displays in windows. For instance, in one example, a method performed by a processing system including at least one processor includes detecting an input from a user of an augmented reality display that is deployed within a window, the input indicating that the user is seeking additional information about a real world object that is viewable through the window, identifying the real world object for which the user is seeking additional information, based on the input from the user and a reference map, retrieving information about the real world object from a data source, and modifying the augmented reality display to present the information about the real world object.

In another example, a non-transitory computer-readable medium stores instructions which, when executed by a processing system, including at least one processor, cause the processing system to perform operations. The operations include detecting an input from a user of an augmented reality display that is deployed within a window, the input indicating that the user is seeking additional information about a real world object that is viewable through the window, identifying the real world object for which the user is seeking additional information, based on the input from the user and a reference map, retrieving information about the real world object from a data source, and modifying the augmented reality display to present the information about the real world object.

In another example, a device includes a processing system including at least one processor and a computer-readable medium storing instructions which, when executed by the processing system, cause the processing system to perform operations. The operations include detecting an input from a user of an augmented reality display that is deployed within a window, the input indicating that the user is seeking additional information about a real world object that is viewable through the window, identifying the real world object for which the user is seeking additional information, based on the input from the user and a reference map, retrieving information about the real world object from a data source, and modifying the augmented reality display to present the information about the real world object.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure may operate;

FIG. 2 illustrates one example configuration of the display of FIG. 1 which has been configured as a window;

FIG. 3 illustrates a flowchart of an example method for providing an interactive augmented reality display in accordance with the present disclosure;

FIG. 4 illustrates the augmented reality display of FIG. 1 in a form that has been modified to display information about two local landmarks that are viewable via the augmented reality display;

FIG. 5 illustrates a flowchart of an example method for providing an interactive augmented reality display in accordance with the present disclosure; and

FIG. 6 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides interactive augmented reality (AR) displays, such as windows which may be used to present information about objects that are viewable through the windows. As discussed above, AR comprises a subset of extended reality (XR) technology in which objects that reside in the real world are augmented with computer-generated information. As such, AR technologies may be well suited to industries in which information about specific sets of real world objects needs to be regularly conveyed to or may frequently be desired by individuals, such as the tourism industry (e.g., in hotels, museums, landmarks, tourist attractions, and the like).

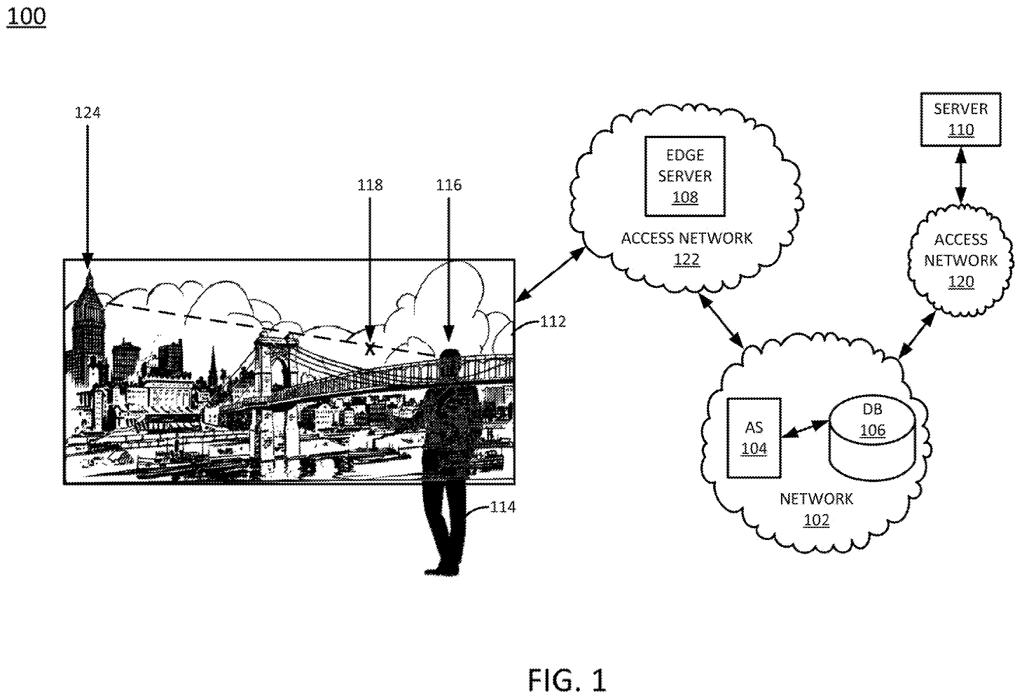

Examples of the present disclosure provide a window which includes display elements that may be activated to provide an interactive AR display. The window may further include sensing elements that are capable of sensing user inputs (e.g., touch inputs, verbal inputs, etc.) and actions (e.g., movements, gaze directions, etc.) which may indicate a desired interaction. The window may identify, based on user inputs (e.g., location and gaze direction, spoken utterances, touch inputs, and the like), an object for which the user desires more information and may present, via the display elements, the desired information. In further examples, the window may cooperate with other devices to carry out desired actions related to the object (e.g., making restaurant reservations, booking hotel rooms, reserving a preferred seat on an airplane or mass transit, choosing a table in a restaurant, purchasing tickets for tourist attractions, movies, plays, and the like, providing zoomed in views, etc.). The interactive AR display may be used in locations such as hotel rooms, landmarks (e.g., buildings that may also function as tourist attractions, such as the Sears Tower, Empire State Building, and the like), transit hubs (e.g., airports, train stations, and the like), office buildings, museums, zoos, and other locations. These and other aspects of the present disclosure are described in greater detail below in connection with the examples of FIGS. 1-6.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, 5G and the like related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, or an enterprise network comprising infrastructure for computing and communications services of a business, an educational institution, a governmental service, or other enterprises. The network 102 may be in communication with one or more access networks 120 and 122, and the Internet (not shown). In one example, network 102 may combine core network components of a cellular network with components of a triple play service network; where triple-play services include telephone services, Internet or data services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over internet Protocol (VoIP) telephony services. Network 102 may further comprise a broadcast television network, e.g., a traditional cable provider network or an internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video on demand (VoD) server, and so forth.

In one example, the access networks 120 and 122 may comprise broadband optical and/or cable access networks, Local Area Networks (LANs), wireless access networks (e.g., an IEEE 802.11/Wi-Fi network and the like), cellular access networks, Digital Subscriber Line (DSL) networks, public switched telephone network (PSTN) access networks, 3^{rd} party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like.

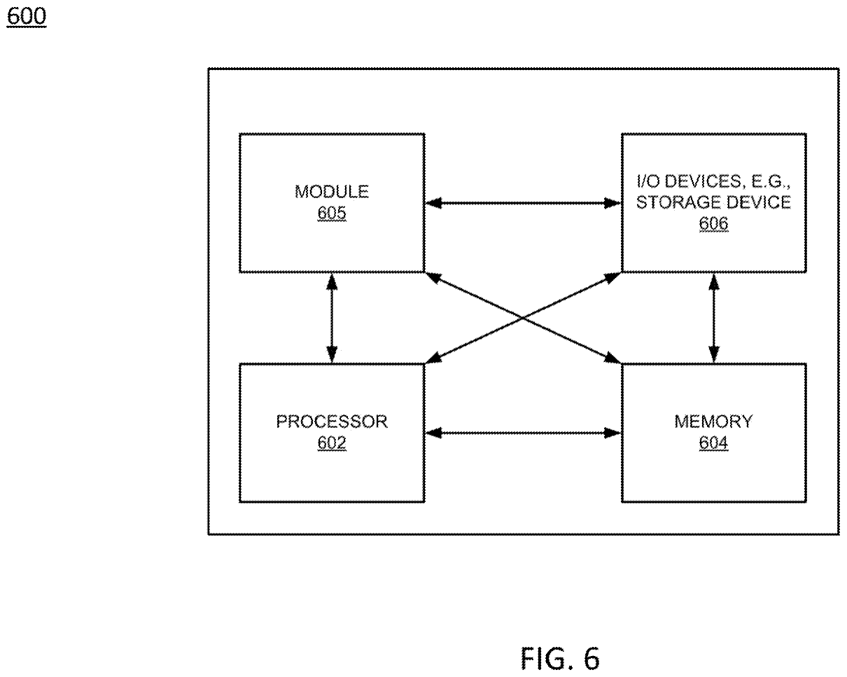

In accordance with the present disclosure, network 102 may include an application server (AS) 104, which may comprise a computing system or server, such as computing system 600 depicted in FIG. 6, and may be configured to provide one or more operations or functions in connection with examples of the present disclosure for providing an interactive augmented reality display. The network 102 may also include a database (DB) 106 that is communicatively coupled to the AS 104.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 6 and discussed below) or multiple computing devices collectively configured to perform various steps, functions, and/or operations in accordance with the present disclosure. Thus, although only a single application server (AS) 104 and single database (DB) are illustrated, it should be noted that any number of servers may be deployed, and which may operate in a distributed and/or coordinated manner as a processing system to perform operations in connection with the present disclosure.

In one example, AS 104 may comprise a centralized network-based server for providing an interactive augmented reality display. For instance, the AS 104 may host an application that communicates with a remote augmented reality display (e.g., display 112 discussed in greater detail below) in order to present information to a user in an interactive manner. For instance, in one example, the augmented reality display may be a window, where the window may be located in a hotel room, a tourist attraction (e.g., a zoo or an observation deck of a building), a transit hub (e.g., a train station or airport) or the like. The augmented reality display may send information about a user's interactions with the augmented reality display (e.g., the user's location and a point on the remote display at which the user is gazing, utterances spoken by the user while gazing at the augmented reality display, points on the augmented reality display that the user has touched, etc.). Based on the information about the user's interactions with the augmented reality display, the AS 104 may determine an object (e.g., a landmark, a building, etc.) in which the user is interested. The AS 104 may provide information about the object to the augmented reality display for display to the user. For instance, in one example, the AS 104 may generate a digital overlay containing the information, where the augmented reality display may present the digital overlay on the surface of the window. In another example, the AS 104 may simply provide information to the augmented reality display, and the augmented reality display may generate the digital overlay using the information.

In one example, AS 104 may comprise a physical storage device (e.g., a database server), to store a reference map that maps user locations relative to the augmented reality display and points on the augmented reality display at which the user may be gazing (or pointing or touching) to objects in the real world that are viewable via the augmented reality display. In other words, the reference map provides a best estimate as to the real world object that a user is likely to be looking at, given the user's location and gaze direction. In one example, the reference map may further map known information sources (e.g., databases, web sites, etc.) to each of the objects, where the known information sources comprise sources from which information about the objects may be retrieved. In one example, the AS 104 may store a plurality of reference maps, where each reference map is associated with (e.g., calibrated for) a different augmented reality display. For instance, an augmented reality display deployed in a window in a hotel room on the Upper East Side of Manhattan will have a different view than an augmented reality display deployed in a window in a convention center on the Hudson River. Thus, different reference maps will be stored for these two example augmented reality displays.

In one example, the DB 106 may store the reference maps, and the AS 104 may retrieve the appropriate reference map from the DB 106 when needed. For ease of illustration, various additional elements of network 102 are omitted from FIG. 1.

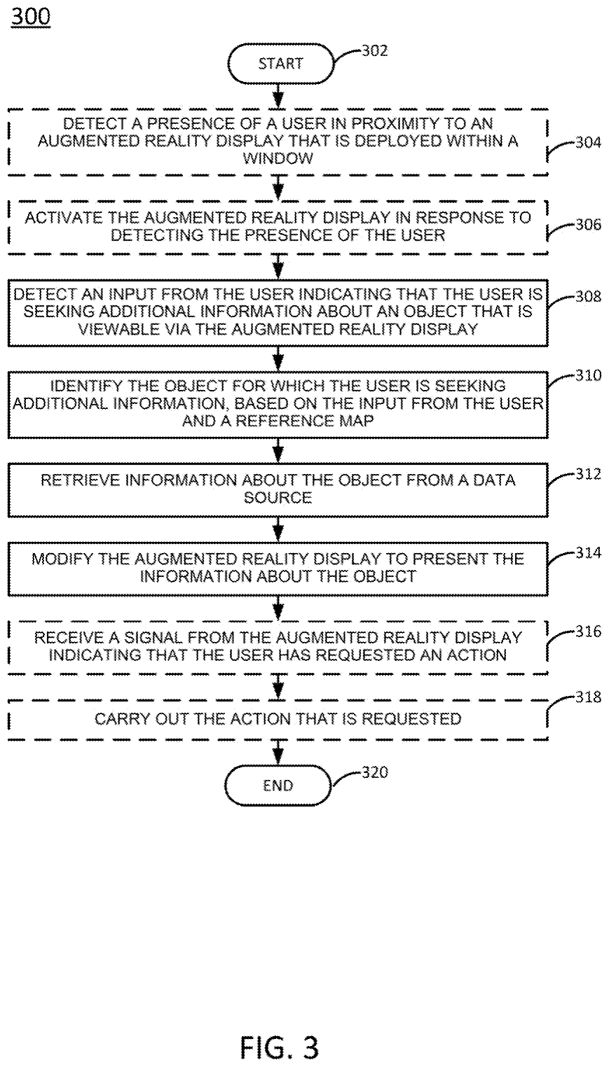

In one example, access network 122 may include an edge server 108, which may comprise a computing system or server, such as computing system 600 depicted in FIG. 6, and may be configured to provide one or more operations or functions for providing an interactive augmented reality display, as described herein. For instance, an example method 300 for providing an interactive augmented reality display is illustrated in FIG. 3 and described in greater detail below.

In one example, application server 104 may comprise a network function virtualization infrastructure (NFVI), e.g., one or more devices or servers that are available as host devices to host virtual machines (VMs), containers, or the like comprising virtual network functions (VNFs). In other words, at least a portion of the network 102 may incorporate software-defined network (SDN) components. Similarly, in one example, access networks 120 and 122 may comprise “edge clouds,” which may include a plurality of nodes/host devices, e.g., computing resources comprising processors, e.g., central processing units (CPUs), graphics processing units (GPUs), programmable logic devices (PLDs), such as field programmable gate arrays (FPGAs), or the like, memory, storage, and so forth. In an example where the access network 122 comprises radio access networks, the nodes and other components of the access network 122 may be referred to as a mobile edge infrastructure. As just one example, edge server 108 may be instantiated on one or more servers hosting virtualization platforms for managing one or more virtual machines (VMs), containers, microservices, or the like. In other words, in one example, edge server 108 may comprise a VM, a container, or the like.

In one example, the access network 120 may be in communication with a server 110. Similarly, access network 122 may be in communication with one or more devices, including, e.g., an interactive augmented reality display 112 (hereinafter also referred to as a “display 112”) and other devices such as a mobile device, a cellular smart phone, a wearable computing device (e.g., smart glasses, a virtual reality (VR) headset or other types of head mounted display, or the like), a laptop computer, a tablet computer, or the like. Access networks 120 and 122 may transmit and receive communications between server 110, display 112 other devices, application server (AS) 104, other components of network 102, devices reachable via the Internet in general, and so forth. In one example, display 112 may comprise a window having built-in display elements that may present digitally created objects in a manner such that, when the digitally created objects are viewed simultaneously with the real world objects visible through the window, and augmented reality display is created. In one example, display 112 may comprise a computing system or device, such as computing system 600 depicted in FIG. 6, and may be configured to provide one or more operations or functions in connection with examples of the present disclosure for providing an interactive augmented reality display. For example only, computing system 600 may comprise components of see-through displays, e.g., transparent organic light-emitting diodes (OLEDs).

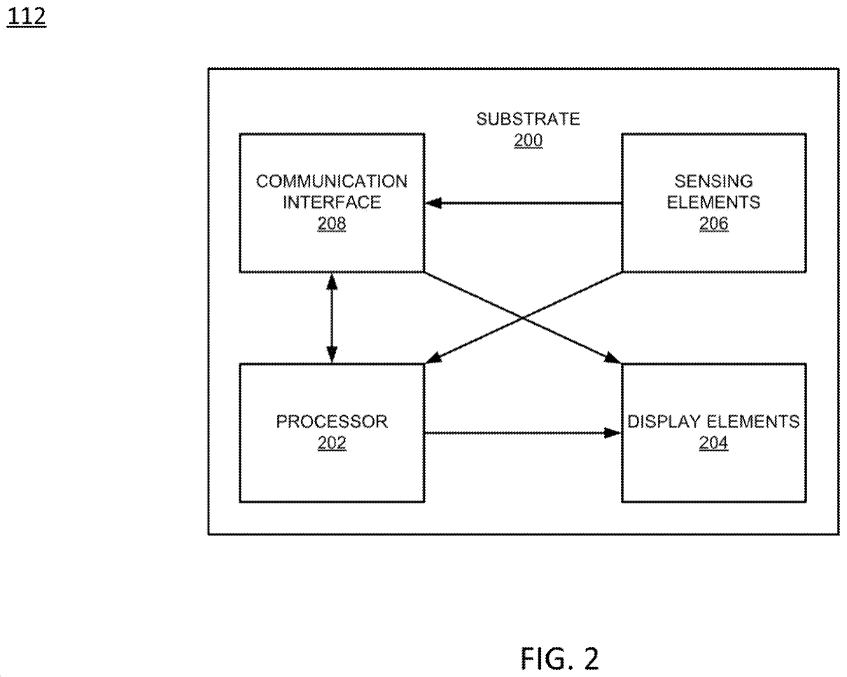

As discussed above, in one particular example, the display 112 comprises a window, i.e., a transparent wall or opening or panel in a wall, door, roof, or the like. FIG. 2, for instance, illustrates one example configuration of the display 112 of FIG. 1 which has been configured as a window. For instance, the display 112 may comprise a transparent substrate 200 in which a processor 202, a plurality of display elements 204, a plurality of sensing elements 206, and a communication interface 208 are embedded. The processor 202 may comprise, for example, a microprocessor, a central processing unit (CPU), or the like. The processor 202 may be in communication with, and may in some cases control operations of, the plurality of display elements 204, the plurality of sensing elements 206, and the communication interface 208.

The plurality of display elements 204 may comprise a plurality of pixels or similar display elements (e.g., display elements that are capable of emitting light and/or color). Each display element of the plurality of display elements 204 may be independently addressable by the processor 202. Thus, the processor 202 may send signals to specific display elements that may cause the specific display elements to change their appearances (e.g., change color, change the intensity of the light emitted, etc.). When all of the specific display elements addressed by the processor 202 change their appearances as instructed by the processor 202, the specific display elements may collectively form a desired image.

The plurality of sensing elements 206 may comprise a plurality of different types of sensors. For instance, the plurality of sensing elements 206 may include one or more of: image sensors (e.g., cameras), audio sensors (e.g., microphones), proximity sensors (e.g., infrared sensors, radio frequency ID sensors, and the like), and touch sensors (e.g., capacitive touch sensors, resistive touch sensors, and the like). In another example, the plurality of sensing elements 206 may also include short range wireless antennas (e.g., Bluetooth antennas, ZigBee antennas, Impulse Radio Ultra Wide Band (IR-UWB) antennas, and the like). The plurality of sensing elements 206 may provide streams of raw sensor data to the processor 202 for further analysis and processing. In one example, additional sensing elements 206 may be located externally to (e.g., not embedded in) the augmented reality display 112. For instance, additional sensing elements may be located throughout a room in which the augmented reality display 112 is deployed.

The communication interface 208 may comprise circuitry that allows the display 112 to communicative with one or more external devices (e.g., over short range or long range wireless protocols). For instance, the communication interface 208 may allow the processor 202 to send data to and receive data from a remote server (e.g., AS 104 and/or server 110), a mobile device that is in proximity to (e.g., within detection range of a short range wireless antenna of) the display 112 (e.g., a user's mobile phone, smart watch, augmented reality glasses, or the like). Thus, the communication interface 208 may comprise one or more transceivers, antennas, network access cards, and/or interfaces that facilitate communication with other devices.

As discussed above, the display 112 may comprise or may be integrated in a window. A window, by its nature, will have a fixed field of view. However, the view seen from the window by a specific user will depend upon the user's orientation with respect to the window. For instance, referring back to FIG. 1, the view seen by the user 114 will change if the user 114 moves from the right side of the window to the left side of the window, or moves closer to the window or further away from the window. Moreover, the view seen by the user 114 may also change if the user 114 turns his head or changes the direction of his gaze. For instance, the user 114 may look down at a boat in the water or may look up at the top of a skyscraper without changing his position with respect to the window.

Thus, in one example, a reference map may be created for the augmented reality display 112. In one example, the reference map comprises a data structure that maps specific viewable objects to specific combinations of user location and points on the augmented reality display 112. In other words, the reference map may identify, given a location of the user with respect to the augmented reality display 112 (indicated by reference numeral 116 in FIG. 1) and a point on the augmented reality display on which the user's gaze is focused (indicated by reference numeral 118 in FIG. 1), an object that the user is likely to be looking at (indicated by reference numeral 124 in FIG. 1). Table 1 (below), for instance, shows a portion of an example reference map that may be associated with the augmented reality display 112 illustrated in FIG. 1.

TABLE 1
Example Reference Map

| User | Gaze | | | |
|---|---|---|---|---|
| Location | Point | Coordinates | Landmark | Metadata Link |
| A | X | 40.7061°N, | Brooklyn | brooklynbridgepark.org |
| | | 73.9969°W | Bridge | |
| A | Y | 40.7126°N, | Woolworth | thewoolworthtower.com |
| | | 74.0083°W | Building | |
| B | Z | 40.7071°N, | South Street | seaportdistrict.nyc |
| | | 74.0035°W | Seaport | |

The user location field may define a location of the user with respect to the augmented reality display 112. The user location may indicate some radius within a defined distance of a specific point (e.g., x feet surrounding a point that is y feet to the northwest of the eastern edge of the augmented reality display 112). Thus, the user location may comprise a location or range of locations within a room that houses the augmented reality display 112. The gaze point field may define a specific point (or radius within some defined distance of a specific point) on the augmented reality display 112. The coordinates field may define the geographic latitude and longitude of the point that is directly viewable given the combination of user location and gaze point (e.g., if the user is looking at gaze point Y from user location A, then the user is likely to be looking at a point having coordinates of 40.7126° N, 74.0083° W). Although shown in Table 1 as latitude/longitude/altitude coordinates, the coordinates may also be specified in some other manner (e.g., as x,y,z coordinates in a Cartesian system). The landmark field may identify a landmark or point of interest that is closest to a set of coordinates (e.g., if the user is determined to be looking at a point having coordinates of 40.7126° N, 74.0083° W, then the user is likely to be looking at the Woolworth Building). The metadata link field may identify a data source from which information about the landmark or point of interest indicated in the landmark field may be retrieved.

By mapping a number of gaze point-to-coordinate extrapolations to identify landmarks and points of interest, a reference map may be created that specifies a number of coordinate sets and/or landmarks and points of interest that may be seen from a given user location. Mapping of the augmented reality display 112 may be performed using a plurality of reference user locations, prior to use of the augmented reality display by a user. For instance, a party who is installing the augmented reality display 112 may perform a calibration process by moving a test subject to different locations near the augmented reality display 112 having the test subject gaze at different points on the augmented reality display 112 while positioned at the different locations, and recording the coordinates and/or landmarks and points of interest that are viewable. In another example, the reference map may be populated using existing data and metadata that describes the geographic vicinity of the augmented reality display 112. In yet another example, an unmanned vehicle (e.g., a drone) equipped with light detection and ranging (LIDAR) capabilities may be used to collect mapping data from the geographic vicinity of the augmented reality display 112.

In one example, server 110 may comprise a network-based server for generating AR media. In this regard, server 110 may comprise the same or similar components as those of AS 104 and may provide the same or similar functions. Thus, any examples described herein with respect to AS 104 may similarly apply to server 110, and vice versa. In particular, server 110 may be a component of an AR system operated by an entity that is not a telecommunications network operator. For instance, a provider of an AR system may operate server 110 and may also operate edge server 108 in accordance with an arrangement with a telecommunication service provider offering edge computing resources to third-parties. However, in another example, a telecommunication network service provider may operate network 102 and access network 122, and may also provide an AR system via AS 104 and edge server 108. For instance, in such an example, the AR system may comprise an additional service that may be offered to subscribers, e.g., in addition to network access services, telephony services, traditional television services, and so forth.

In an illustrative example, an AR system may be provided via AS 104 and edge server 108. In one example, a user may engage an application on display 112 to establish one or more sessions with the AR system, e.g., a connection to edge server 108 (or a connection to edge server 108 and a connection to AS 104). In one example, the access network 122 may comprise a cellular network (e.g., a 4G network and/or an LTE network, or a portion thereof, such as an evolved Uniform Terrestrial Radio Access Network (eUTRAN), an evolved packet core (EPC) network, etc., a 5G network, etc.). Thus, the communications between display 112 and edge server 108 may involve cellular communication via one or more base stations (e.g., eNodeBs, gNBs, or the like). However, in another example, the communications may alternatively or additional be via a non-cellular wireless communication modality, such as IEEE 802.11/Wi-Fi, or the like. For instance, access network 122 may comprise a wireless local area network (WLAN) containing at least one wireless access point (AP), e.g., a wireless router. Alternatively, or in addition, display 112 may communicate with access network 122, network 102, the Internet in general, etc., via a WLAN that interfaces with access network 122.

It should also be noted that the system 100 has been simplified. Thus, it should be noted that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102, access networks 120 and 122, and/or Internet may comprise a content distribution network (CDN) having ingest servers, edge servers, and the like for packet-based streaming of video, audio, or other content. Similarly, although only two access networks, 120 and 122 are shown, in other examples, access networks 120 and/or 122 may each comprise a plurality of different access networks that may interface with network 102 independently or in a chained manner. In addition, as described above, the functions of AS 104 may be similarly provided by server 110, or may be provided by AS 104 in conjunction with server 110. For instance, AS 104 and server 110 may be configured in a load balancing arrangement, or may be configured to provide for backups or redundancies with respect to each other, and so forth. Thus, these and other modifications are all contemplated within the scope of the present disclosure.

To further aid in understanding the present disclosure, FIG. 3 illustrates a flowchart of a method 300 for providing an interactive augmented reality display in accordance with the present disclosure. In one example, the method 300 may be performed by a server that is configured to generate digital overlays that may be superimposed over images of a “real world” environment viewed through a window to produce an augmented reality display, such as the AS 104 or server 110 or display 112 illustrated in FIG. 1. However, in other examples, the method 300 may be performed by another device, such as the processor 602 of the system 600 illustrated in FIG. 6. For the sake of example, the method 300 is described as being performed by a processing system.

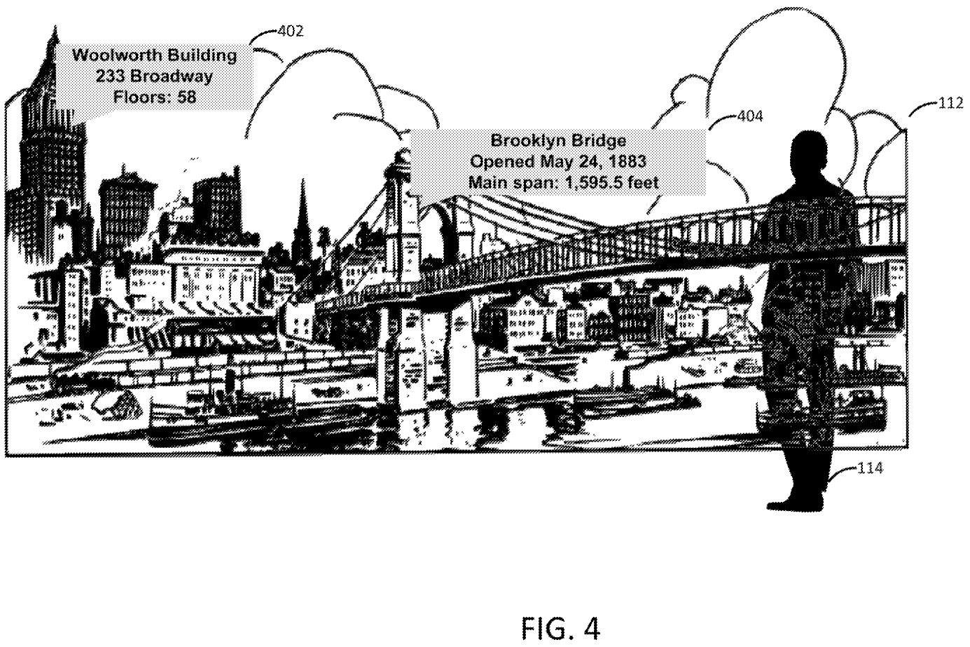

The method 300 begins in step 302. In optional step 304 (illustrated in phantom), the processing system may detect a presence of a user in proximity to an augmented reality display that is deployed within a window. As discussed above, in one example, the augmented reality display may comprise a window having display elements embedded in a transparent substrate, such that augmented reality content may be presented to the user without obstructing the user's view of objects on the other side of the window. For instance, the window may comprise a window in a hotel room, an office building, a transit hub, a landmark, or the like. As an example, FIG. 4 illustrates an example augmented reality display 112 that comprises a window looking out over a portion of the New York City skyline.

In one example, the presence of the user may be detected via an analysis of signals received from sensing elements embedded in the transparent substrate of the window. The sensing elements may include, for instance one or more of: image sensors (e.g., cameras), audio sensors (e.g., microphones), proximity sensors (e.g., infrared sensors, radio frequency ID sensors, and the like), and touch sensors (e.g., capacitive touch sensors, resistive touch sensors, and the like). In another example, the sensing elements may include short range wireless antennas (e.g., Bluetooth antennas, ZigBee antennas, Impulse Radio Ultra Wide Band (IR-UWB) antennas, and the like).

For instance, the presence of the user may be detected when an image sensor embedded in the window captures an image of the user standing in front of the window. The presence of the user may also be detected when an audio sensor embedded in the window captures a noise made by the user (e.g., a statement such as “What is that?” or a cough or other vocalizations, footsteps, a door opening, or the like). The presence of a user may also be detected when a touch sensor embedded in the window captures a touch input from the user (e.g., the user tapping or pointing on the window). The presence of the user may also be detected when an obstruction in a beam or field of electromagnetic radiation emitted by a proximity sensor is detected. The presence of the user may also be detected when a short range wireless antenna embedded in the window detects the presence of the user's wireless device (e.g., mobile phone, smart watch, pair of AR glasses, or the like).

In another example, the augmented reality display may detect the presence of the user (via any of the methods described above) and may send a signal to the processing system informing the processing system that a user presence has been detected.

In optional step 306 (illustrated in phantom), the processing system may activate the augmented reality display in response to detecting the presence of the user. For instance, when a user presence is not detected, the augmented reality display may power off or enter a “sleep” or similar mode of operation in order to conserve power. However, once a user presence is detected, the processing system may activate the augmented reality display by sending a signal to the augmented reality display to power on or wake. Activating the augmented reality display may further involve presenting default augmented reality content on the augmented reality display.

For instance, in one example, activation of the augmented reality display may involve generating a digital overlay that may be presented by altering the appearance of the display elements that are embedded in the augmented reality display. As an example, if the augmented reality display is a window overlooking a city skyline, then the display elements may be altered to present information (e.g., names) about various landmarks and locations that are viewable in the skyline through the windows, or to present a welcome screen or menu (e.g., the message “Welcome to New York,” the local date, time, and/or temperature, or the like). The processing system may send signals to the display elements of the augmented reality display that cause the display elements to alter their appearances to present the desired information in desired locations on the display.

In another example, the augmented reality display may be programmed to generate and display default augmented reality content without prompting from the processing system; however, the processing system may provide further augmented reality content responsive to interactions of the augmented reality display with a user as described in connection with steps 308-318.

In step 308, once the augmented reality display is activated, the processing system may detect an input from the user indicating that the user is seeking additional information about an object that is viewable via the augmented reality display. The input may be detected in one or more signals received from the sensing elements of the augmented reality display. For instance, in one example, the input may comprise an audible utterance detected via a microphone (e.g., “What is that building?”). In another example, the input may be a touch input detected via a touch sensor (e.g., the user may touch a portion of the augmented reality display that is showing the name of a building). In another example, the input may be a gaze input detected via a camera (e.g., a location of the user relative to the augmented reality display plus a point on the augmented reality display on which the user's gaze is determined to be fixed). In one example, the input may be a combination of two or more of these or other inputs (e.g., the user says “What is that building?” while gazing at a specific point on the augmented reality display that is mapped, via a reference map, to a specific building). Thus, in one example, the processing system may detect the user input in raw data streams delivered by the sensing elements of the augmented reality display. However, in other examples, the augmented reality display may process the data streams locally in order to detect the user input and may provide the detected user input to the processing system.

In step 310, the processing system may identify the object for which the user is seeking additional information, based on the input from the user and a reference map as described above. For instance, as discussed above, where the input identifies a location of the user relative to the augmented reality display plus a point on the augmented reality display at which the user appears to be gazing, the processing system may map these inputs, via a reference map, to a specific object (e.g., landmark or point of interest) that is viewable via the augmented reality display. In another example, where the input is a touch input, the processing system may identify an object for which information is being displayed on the augmented reality display in the region where the user touched the augmented reality display.

In step 312, the processing system may retrieve information about the object from a data source. As discussed above, where the object is identified in a reference map, the reference map may identify one or more data sources containing information about the object. In another example (e.g., where the reference map does not indicate a data source containing information about the object, or where the information source may not contain the specific data requested), the processing system may query one or more external data sources (e.g., the Internet or other sources) for information about the object.

In step 314, the processing system may modify the augmented reality display to present the information about the object. For instance, the processing system may generate a digital overlay that may be presented by altering the appearance of the display elements that are embedded in the augmented reality display and may send this digital overlay to the augmented reality display. As an example, if the augmented reality display is a window overlooking a city skyline, and the user touched the name of a specific landmark on the augmented reality display (the input), then the digital overlay generated in step 314 may present information (e.g., in text and/or image form) about that specific landmark. FIG. 4, for instance, illustrates the augmented reality display 112 of FIG. 1 in a form that has been modified to display information about two local landmarks that are viewable via the augmented reality display 112 (i.e., the Woolworth Building and the Brooklyn Bridge in lower Manhattan). In one example, the information is provided in text boxes or bubbles 402 and 404. In the example illustrated in FIG. 4, the information indicates the address and number of floors in the Woolworth Building, and the opening date and length of the span of the Brooklyn Bridge. The processing system may send signals to the display elements of the augmented reality display that cause the display elements to alter their appearances to present the desired information in desired locations on the display (e.g., to present the bubbles 402 and 404).

In one example, the information presented in step 314 may include options to perform actions. Some of these actions may comprise further modifications to the augmented reality display, while some of these actions may involve interaction with other computing systems not including the augmented reality display. For instance, if the augmented reality display is modified to present information about a tourist attraction (e.g., the Statue of Liberty), the information presented may include an option to purchase tickets to visit the tourist attraction, an option to view the operating schedule of the tourist attraction, an option to view mass transit routes to the tourist attraction from the location of the augmented reality display, an option to request a taxi or rideshare to the tourist attraction, an option to zoom in on the tourist attraction in a portion of the augmented reality display, and the like. If the augmented reality display is modified to present information about a restaurant, the information presented may include an option to make a reservation at the restaurant, an option to select a specific table in the restaurant, an option to view the restaurant's menu, an option to place a delivery order with the restaurant, an option to view mass transit or walking routes to the restaurant, an option to request a taxi or rideshare to the restaurant, and the like.

In optional step 316 (illustrated in phantom), the processing system may receive a signal from the augmented reality display indicating that the user has requested an action. For instance, as discussed above, the action may be related to the information that is presented in step 314 (e.g., a request to make a restaurant reservation, book a hotel room, reserve a preferred seat on an airplane or mass transit, choose a table in a restaurant, purchase tickets to a tourist attraction, a movie, or a play, or the like). The signal may be detected or received in any of the manners discussed above with respect to step 308.

In optional step 318 (illustrated in phantom), the processing system may carry out the action that is requested. In one example, carrying out the action may involve communicating with an external data source (e.g., a web site for a restaurant or tourist attraction). Carrying out the action may also involve requesting additional information from the user (e.g., desired day and time of restaurant reservation, desired table or seating location, credit card number to purchase tickets, etc.). In another example, carrying out the information may involve sending signals to another device to perform the action. For instance, the processing system may send an instruction to the user's mobile phone instructing the mobile phone to call a phone number associated with a restaurant or may open a ridesharing application on the user's mobile phone to request a rideshare to the restaurant.

In an example where the user requests that the view of a particular object zoom in, the processing system may search for sensors that are in the vicinity of the object (e.g., closed-circuit cameras, public video feeds, real-time user-generated content shared through social media, etc.) and may display information from these sensors on the augmented reality display. The zoomed-in information (e.g., video, still images, and/or audio) may be displayed, for example, within a designated window on the augmented reality display (e.g., as a picture in a picture).

In another example, the requested action may be to find a person or object. For instance, mobile device users may elect to share their location data with the processing system. If the user then asks “Where is Bob?,” and Bob has elected to share the location of his mobile phone with the processing system, then the processing system may be able to determine Bob's location and may cause the augmented reality display to display a marker indicating Bob's current location. The marker may include an arrow or bubble placed approximately in Bob's location and may additionally include a text description of Bob's location (e.g., address or name of landmark) or an approximate distance and/or direction (e.g., x miles northwest) to Bob's location.

The method 300 may end in step 320.

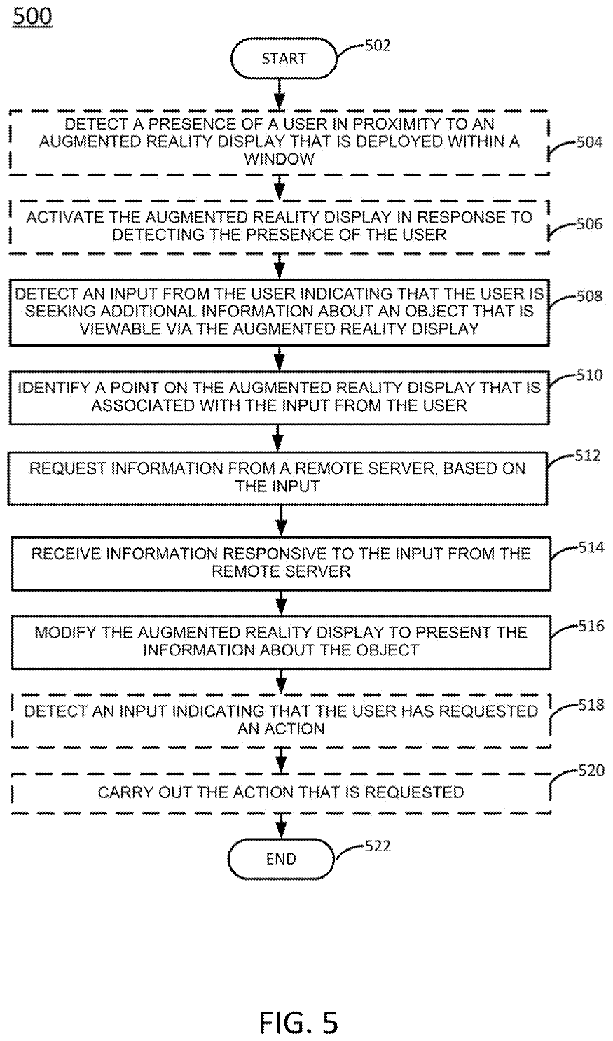

FIG. 5 illustrates a flowchart of a method 500 for providing an interactive augmented reality display in accordance with the present disclosure. In one example, the method 500 may be performed by a processing system of an interactive augmented reality display that is configured to superimpose digital overlays provided by a remote server over images of a “real world” environment viewable through a window to produce an augmented reality display, such as the display 112 illustrated in FIG. 1. However, in other examples, the method 500 may be performed by another device, such as the processor 602 of the system 600 illustrated in FIG. 6. For the sake of example, the method 500 is described as being performed by a processing system.

The method 500 begins in step 502. In optional step 504 (illustrated in phantom), the processing system may detect a presence of a user in proximity to an augmented reality display that is deployed within a window. As discussed above, in one example, the augmented reality display may comprise a window having display elements embedded in a transparent substrate, such that augmented reality content may be presented to the user without obstructing the user's view of objects on the other side of the window. For instance, the window may comprise a window in a hotel room, an office building, a transit hub, a landmark, a museum, a zoo, or the like. As an example, FIG. 4 illustrates an example augmented reality display 112 that comprises a window looking out over a portion of the New York City skyline.

In one example, the presence of the user may be detected via sensing elements embedded in the transparent substrate of the window. The sensing elements may include, for instance one or more of: image sensors (e.g., cameras), audio sensors (e.g., microphones), proximity sensors (e.g., infrared sensors, radio frequency ID sensors, and the like), and touch sensors (e.g., capacitive touch sensors, resistive touch sensors, and the like). In another example, the sensing elements may include short range wireless antennas (e.g., Bluetooth antennas, ZigBee antennas, Impulse Radio Ultra Wide Band (IR-UWB) antennas, and the like).

For instance, the presence of the user may be detected when an image sensor embedded in the window captures an image of the user standing in front of the window. The presence of the user may also be detected when an audio sensor embedded in the window captures a noise made by the user (e.g., a statement such as “What is that?” or a cough or other vocalizations, footsteps, a door opening, or the like). The presence of the user may also be detected when a touch sensor embedded in the window captures a touch input from the user (e.g., the user tapping or pointing on the window). The presence of the user may also be detected when an obstruction in a beam or field of electromagnetic radiation emitted by a proximity sensor is detected. The presence of the user may also be detected when a short range wireless antenna embedded in the window detects the presence of the user's wireless device (e.g., mobile phone, smart watch, pair of AR glasses, or the like).

In optional step 506 (illustrated in phantom), the processing system may activate the augmented reality display in response to detecting the presence of the user. For instance, when a user presence is not detected and/or no user input is received for a threshold period of time, the augmented reality display may power off or enter a “sleep” or similar passive mode of operation in order to conserve power. However, once a user presence is detected, the processing system may activate the augmented reality display by sending a signal to the augmented reality display to power on or wake. Activating the augmented reality display may further involve presenting default augmented reality content on the augmented reality display (e.g., a welcome screen or menu). As discussed above, the default augmented reality content may be provided by a remote server or may be stored locally on the augmented reality display.

For instance, in one example, activation of the augmented reality display may involve altering the appearance of the display elements that are embedded in the augmented reality display. As an example, if the augmented reality display is a window overlooking a city skyline, then the display elements may be altered to superimpose information over the view through the window. The default augmented reality content that is displayed upon waking in this case may comprise, for instance, the text-based message “Welcome to New York,” the date, the time, the local weather conditions, and/or other information. The processing system may send signals to the display elements of the augmented reality display that cause the display elements to alter their appearances to present the desired information in desired locations on the display.

In step 508, once the augmented reality display is activated, the processing system may detect an input from the user indicating that the user is seeking additional information about an object that is viewable via the augmented reality display. The input may be detected in one or more signals received from the sensing elements of the augmented reality display. For instance, in one example, the input may comprise an audible utterance detected via a microphone (e.g., “What is that building?”). In another example, the input may be a touch input detected via a touch sensor (e.g., the user may touch a portion of the augmented reality display that is showing the name of a building). In another example, the input may be a gaze input detected via a camera (e.g., a location of the user relative to the augmented reality display plus a point on the augmented reality display on which the user's gaze is determined to be fixed). In one example, the input may be a combination of two or more of these or other inputs (e.g., the user says “What is that building?” while gazing at or pointing to a specific point on the augmented reality display that is mapped, via a reference map, to a specific building).

In optional step 510 (illustrated in phantom), the processing system may identify a point on the augmented reality display that is associated with the input from the user. For instance, where the input is a touch input, the processing system may identify the point on the augmented reality display at which the touch input was received. Where the input is a user gaze, the processing system may identify the point on the augmented reality display at which the user is gazing.

In step 512, the processing system may request information from a remote server, based on the input. For instance, in one example, the processing system may provide to the remote server the point on the augmented display that is associated with the input (e.g., as determined in step 510). In another example, the processing system may also provide to the remote server the location of the user (e.g., where the user is positioned relative to the augmented reality display). In another example, the processing system may also provide to the remote server any spoken utterances or audible inputs uttered by the user. In another example, the processing system may provide a different kind of input to the remote server (e.g., a gesture, a presence, a biometric measurement, etc.).

In step 514, the processing system may receive information responsive to the input from the remote server. In one example, the information relates to an object that is viewable through the augmented reality display, where the remote server identifies the object from the input using any of the techniques described in connection with FIG. 3. The information received in step 514 may include text, images, video, audio, and/or other types of information. For instance, the information may identify the object, the object's location (e.g., address), facts about the object (e.g., operating schedule, historical facts, etc.), and the like. In one example, the information may be provided in a digital overlay that the augmented reality display may superimpose over the view of the real world objects (e.g., over the window). In another example, the information is provided in raw form.

In step 516, the processing system may modify the augmented reality display to present the information received from the remote server. For instance, where the information is received as a digital overlay, the processing system may instruct certain display elements embedded in the augmented reality display to modify their appearances to present the digital overlay. Where the information is received in raw form, the processing system may locally generate a digital overlay. As an example, if the augmented reality display is a window overlooking a city skyline, and the user touched the name of a specific landmark that was presented on the augmented reality display (the input), then the digital overlay generated in step 516 may present information (e.g., in text and/or image form) about that specific landmark that was provided by the remote server. The processing system may send signals to the display elements of the augmented reality display that cause the display elements to alter their appearances to present the desired information in desired locations on the display.

In one example, the information presented in step 516 may include options to perform actions. Some of these actions may comprise further modifications to the augmented reality display, while some of these actions may involve interaction with other computing systems not including the augmented reality display. For instance, if the augmented reality display is modified to present information about a tourist attraction (e.g., the Statue of Liberty), the information presented may include an option to purchase tickets to visit the tourist attraction, an option to view the operating hours of the tourist attraction, an option to view mass transit routes to the tourist attraction from the location of the augmented reality display, an option to request a taxi or rideshare to the tourist attraction, an option to zoom in on the tourist attraction in a portion of the augmented reality display, and the like. If the augmented reality display is modified to present information about a restaurant, the information presented may include an option to make a reservation at the restaurant, an option to view the restaurant's menu, an option to select a specific table in the restaurant, an option to place a delivery order with the restaurant, an option to view mass transit or walking routes to the restaurant, an option to request a taxi or rideshare to the restaurant, and the like.

In optional step 518 (illustrated in phantom), the processing system may detect a user input indicating that the user has requested an action. For instance, as discussed above, the action may be related to the information that is presented in step 516 (e.g., a request to make a restaurant reservation, book a hotel room, reserve a preferred seat on an airplane or mass transit, choose a table in a restaurant, purchase tickets to a tourist attraction, a movie, or a play, or the like). The user input may be detected in any of the ways that the input was received in step 508.

In optional step 520 (illustrated in phantom), the processing system may send an instruction to another device to carry out the action that is requested. For example, the processing system may send the instruction to the remote server, to the user's mobile device, or to another device that is capable of accessing an external data source (e.g. a web site for a restaurant or tourist attraction) to carry out the action.

The method 500 may end in step 522.

Thus, an augmented reality display that is built into a window may cooperate with a remote server, and optionally with other remote or local devices, to identify real world objects that a user is viewing through the window and to present information about those real world objects to the user. However, in other examples, the augmented reality display may identify the real world objects and retrieve the information about the real world objects without the help the remote server. In further examples, actions related to the real world objects (such as the booking of restaurant reservations, booking hotel rooms, reserving a preferred seat on an airplane or mass transit, choosing a table in a restaurant, purchase of tickets to a tourist attraction, a movie, a play, or the like, zooming or presentation of additional views, etc.) may also be carried out in response to a request from the user.

In further examples still, the augmented reality display may be used to present information about real world objects that may not be visible to the user through the window. For instance, where a view of an object from the window may be obstructed (e.g., a view of a landmark may be obstructed by a large building that is positioned between the window and the landmark or by scaffolding that is erected around the landmark), the augmented reality display may be modified to digitally “erase” the obstruction from the view. The obstruction may be erased by presenting saved or real-time images or video of the object being obstructed.

Although not expressly specified above, one or more steps of the method 300 or 500 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 or FIG. 5 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 6 depicts a high-level block diagram of a computing device specifically programmed to perform the functions described herein. For example, any one or more components or devices illustrated in FIG. 1 or described in connection with the methods 300 and 500 may be implemented as the system 600. For instance, a server (such as might be used to perform the method 300) or an augmented reality display (such as might be used to perform the method 500) could be implemented as illustrated in FIG. 6.

As depicted in FIG. 6, the system 600 comprises a hardware processor element 602, a memory 604, a module 605 for providing an interactive augmented reality display, and various input/output (I/O) devices 606.

The hardware processor 602 may comprise, for example, a microprocessor, a central processing unit (CPU), or the like. The memory 604 may comprise, for example, random access memory (RAM), read only memory (ROM), a disk drive, an optical drive, a magnetic drive, and/or a Universal Serial Bus (USB) drive. The module 605 for providing an interactive augmented reality display may include circuitry and/or logic for performing special purpose functions relating to the operation of a home gateway or XR server. The input/output devices 606 may include, for example, a camera, a video camera, a see-through display, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 605 for providing an interactive augmented reality display (e.g., a software program comprising computer-executable instructions) can be loaded into memory 604 and executed by hardware processor element 602 to implement the steps, functions or operations as discussed above in connection with the example method 300 or 500. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 605 for providing an interactive augmented reality display (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
detecting, by a processing system including at least one processor, an input from a user of an augmented reality display that is deployed within a window, the input indicating that the user is seeking additional information about a real world object that is viewable through the window;
identifying, by the processing system, the real world object for which the user is seeking additional information, based on the input from the user and a reference map;
retrieving, by the processing system, information about the real world object from a data source; and
modifying, by the processing system, the augmented reality display to present the information about the real world object.

2. The method of claim 1, wherein the input from the user comprises a location of the user relative to the augmented reality display and a point on the augmented reality display at which the user is gazing.

3. The method of claim 1, wherein the reference map is calibrated specifically for the augmented reality display.

4. The method of claim 3, wherein the reference map is one of a plurality of reference maps to which the processing system has access, and wherein each reference map of the plurality of reference maps is calibrated for a different augmented reality display of a plurality of augmented reality displays.

5. The method of claim 3, wherein the identifying comprises mapping the real world object to a location of the user relative to the augmented reality display and the point on the augmented reality display at which the user is gazing, using the reference map.

6. The method of claim 5, wherein the reference map further maps the real world object to a set of geographic coordinates.

7. The method of claim 5, wherein the reference map further maps the real world object to the data source.

8. The method of claim 7, wherein the data source comprises a web site for the real world object.

9. The method of claim 1, wherein the input from the user comprises a location of the user relative to the augmented reality display and a point on the augmented reality display that is touched by the user.

10. The method of claim 1, wherein the input from the user comprises an utterance spoken by the user and a point on the augmented reality display that is touched by the user.

11. The method of claim 1, further comprising:
receiving, by the processing system, a signal from the augmented reality display indicating that the user has requested an action with respect to the real world object; and
carrying out, by the processing system, the action that is requested.

12. The method of claim 11, wherein the action comprises at least one selected from a group of: booking a reservation, booking a hotel room, reserving a seat on an airplane, reserving a seat on mass transit, choosing a table in a restaurant, purchasing a ticket, viewing an operating schedule, booking a taxi or rideshare, placing an order for food, and zooming in a view on the real world object.

13. The method of claim 11, wherein the carrying out comprises conducting an interaction with a web site associated with the real world object.

14. The method of claim 11, wherein the carrying out comprises causing a mobile device of the user to place a call to a phone number associated with the real world object.

15. The method of claim 11, wherein the carrying out comprises launching an application on a mobile device of the user.

16. The method of claim 1, wherein the window is deployed within at least one of:
a hotel, a tourist attraction, a transit hub, and a landmark.

17. The method of claim 1, wherein the input is detected using a sensing element positioned in proximity to the augmented reality display.

18. The method of claim 17, wherein the sensing element is at least one selected from a group of: an image sensor, an audio sensor, a proximity sensor, a touch sensor, and a short range wireless antenna.

19. A non-transitory computer-readable medium storing instructions which, when executed by a processing system including at least one processor, cause the processing system to perform operations, the operations comprising:
detecting an input from a user of an augmented reality display that is deployed within a window, the input indicating that the user is seeking additional information about a real world object that is viewable through the window;
identifying the real world object for which the user is seeking additional information, based on the input from the user and a reference map;
retrieving information about the real world object from a data source; and
modifying the augmented reality display to present the information about the real world object.

20. A device comprising:
a processing system including at least one processor; and
a computer-readable medium storing instructions which, when executed by the processing system, cause the processing system to perform operations, the operations comprising:
detecting an input from a user of an augmented reality display that is deployed within a window, the input indicating that the user is seeking additional information about a real world object that is viewable through the window;
identifying the real world object for which the user is seeking additional information, based on the input from the user and a reference map;
retrieving information about the real world object from a data source; and
modifying the augmented reality display to present the information about the real world object.
